(19) United States
(12) Patent Application Publication
(10) Pub. No.: US 2026/0111223 A1
(43) Pub. Date: Apr. 23, 2026

(54) System

(71) Applicant: SoftBank Group Corp., Tokyo (JP)

(72) Inventor: Kazuki Aoyama, Tokyo (JP)

(21) Appl. No.: 19/361,508

(22) Filed: Oct. 17, 2025

(30) Foreign Application Priority Data
Oct. 21, 2024 (JP) 2024-185565

(51) Int. Cl. G06F 8/74

(52) U.S. Cl. CPC G06F 8/74

(57) ABSTRACT

A system includes a processor that is configured to acquire source code, analyze the acquired source code and extract operational functions and error conditions, automatically generate a user manual and FAQ in natural language based on the generated data, automatically generate images and videos of operation procedures as rich content, and integrate and distribute the generated content via a management system.

### CROSS-REFERENCE TO RELATED APPLICATION

This application is based on and claims priority under 35 USC 119 from Japanese Patent Application No. 2024-185565 filed on Oct. 21, 2024, the disclosure of which is incorporated by reference herein.

### BACKGROUND

### Technical Field

The present disclosure relates to a system.

Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional methods for creating and updating user manuals and FAQs for software products require significant manual effort, making it difficult to ensure that documentation remains consistent with the latest version of the source code. Changes to the software often do not promptly reflect in the user documentation, leading to outdated information being delivered to the user. Furthermore, providing rich content such as images and videos for operation guidance is labor-intensive, and user feedback is seldom leveraged efficiently for documentation improvement.

### SUMMARY

The present invention provides a system comprising a processor, wherein the processor acquires the latest version of source code, analyzes the source code to extract operation functions and error conditions, and utilizes a natural language generation model to automatically generate user manuals and FAQs. The processor further generates rich content such as images and videos of operation procedures, integrates the generated content into a management system, and distributes it to users. The system automatically detects changes in the source code and updates only the affected sections of the documentation, and also receives and analyzes user feedback to continuously improve the manuals and FAQs.

“Source code” means a collection of computer program instructions written in a programming language, which defines the logic and functions of a software product.

“Operational functions” means executable features or functionalities of the software, which are made available to users and can be called or interacted with through the application.

“Error conditions” means specific situations or input states within the software that cause exceptions, failures, or unwanted outputs, typically requiring error handling or user notification.

“User manual” means a document or set of documents intended to assist users in understanding and effectively operating the software product, which includes instructions, explanations, and guidelines.

“FAQ” means a collection of Frequently Asked Questions, accompanied by answers, which are aimed at addressing common inquiries or problems encountered by users when using the software.

“Natural language generation” means a computational technique or process for automatically producing human-readable text in a natural language based on structured or unstructured input data.

“Rich content” means media elements such as images, videos, animations, or other multimedia resources, which supplement textual explanations and assist users in understanding operation procedures.

“Management system” means a software platform or framework responsible for organizing, storing, updating, and distributing documentation and related content to users.

“Feedback” means information, comments, or suggestions provided by users regarding the use, comprehensibility, or effectiveness of the documentation or the software itself.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

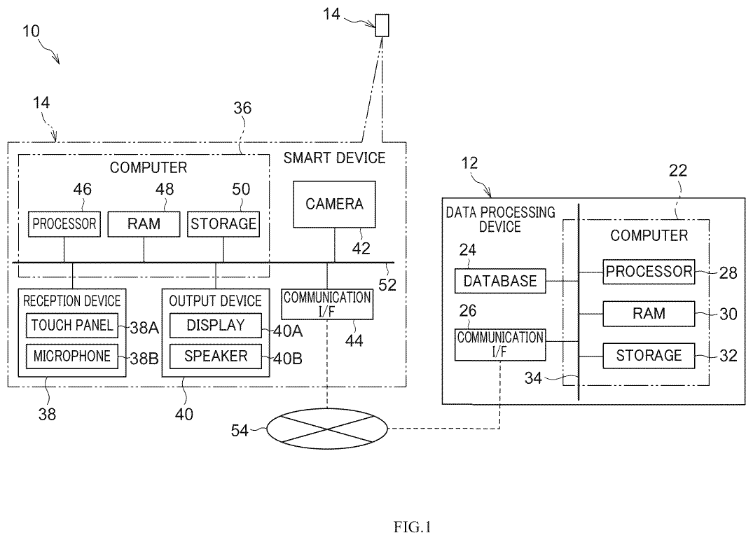

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

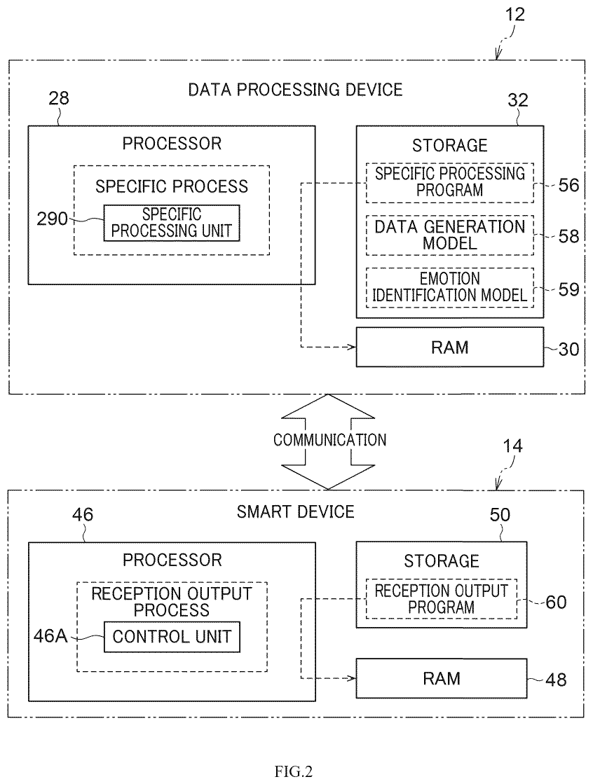

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### EXAMPLE 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional technology, the creation and updating of user manuals and frequently asked questions for software products are largely performed manually, resulting in substantial time and effort requirements. There is also a risk that the information provided to users may not always be up-to-date, leading to inadequate user support. Furthermore, it is difficult to promptly reflect user feedback or to continuously improve the quality of the documentation, including the integration of visual content such as images and videos. Therefore, there is a need for a system that can automatically generate and maintain software documentation, including rich media content, while incorporating user feedback and efficiently reflecting the latest changes in the software.

The specific processing by the specific processing unit 290 of the data processing device 12 in Example 1 is realized by the following means.

The present invention provides a server comprising a processor configured to acquire program information including software structure information, analyze the acquired program information to extract operation function information and abnormal condition information, generate a prompt sentence for a generative artificial intelligence model based on the extracted information, automatically generate document data utilizing the artificial intelligence model, automatically generate image information and video information based on the generated document data, integrate the document data and rich media content, distribute them to a management system, monitor changes in program information for automatic updating, and analyze user feedback to improve the documentation. This enables the automatic and continuous creation, updating, and improvement of comprehensive user documentation, including visual content, thereby offering users the latest information and responsive support.

The term “program information” refers to data that describes the structure, elements, and operational logic of software, including but not limited to source code, scripts, configuration files, and other related documentation.

The term “software structure information” refers to information that outlines the architecture and organization of software, such as modules, functions, classes, interfaces, and the relationships between them.
The term “analysis processing device” refers to computing resources or software tools that perform examination and parsing of program information to extract relevant features, such as operational functions and abnormal conditions.
The term “operation function information” refers to data that identifies and explains the executable functions, methods, and interactive components available to users or other programs within software.
The term “abnormal condition information” refers to data indicating potential error conditions, exceptions, faults, or failure scenarios that can occur during the operation of software.
The term “prompt sentence” refers to a text string composed to deliver specific instructions or questions to a generative artificial intelligence model to elicit targeted natural language output.
The term “generative artificial intelligence model” refers to a machine learning-based system trained to produce natural language text or other content in response to input prompts, typically using deep learning architectures.
The term “document data” refers to textual content automatically generated to explain software operations, user interactions, troubleshooting steps, or frequently asked questions, intended for use in user manuals or support documentation.
The term “image information” refers to visual data, such as diagrams, annotated screenshots, or illustrative graphics, generated or processed to visually assist the understanding of software features or operational steps.
The term “video information” refers to multimedia content, such as recorded or artificially generated motion pictures, screen recordings, or step-by-step demonstration videos, aimed at providing visual explanations for software features or operations.
The term “management information storage area” refers to a data repository or storage subsystem used to retain and manage program information and related metadata for analysis and documentation purposes.
The term “information providing device” refers to any computing mechanism, interface, or communication means that serves to transmit generated documentation and media content to a management system or to end-users.
The term “management system” refers to a platform or infrastructure designed to organize, store, and present documentation, media content, and user support information for access by intended recipients.
The term “evaluation information” refers to data collected from users representing feedback, comments, suggestions, or assessments regarding the quality, accuracy, or usability of documentation or system features.
The term “information display device” refers to any hardware or software component capable of presenting documentation, media, or interactive forms to users, and optionally capturing user interaction or feedback.

An embodiment for implementing the present invention is described as follows. A server, which comprises a processor, memory, one or more storage devices, and network communication interfaces, is the central component for executing the invention. The server is connected to at least one program information repository, such as a version control storage (for example, a general-purpose source code management system). The server is also networked with an information management system, such as a documentation portal or content management platform, and may interface with image and video processing software applications.

The server operates by first acquiring program information, including software structure information, from a management information storage area. Such storage may be external or internally connected storage, implemented as a cloud drive, a local directory, or a database.
The software structure information typically includes, but is not limited to, source code files, configuration scripts, and architectural diagrams.
The processor of the server executes static analysis software, for instance tools such as a general-purpose static analyzer, a code linter, or a script interpreter. The processor analyzes the acquired program information to parse and extract operation function information, such as user-facing functions or features, as well as abnormal condition information including error-handling routines or exception cases. For example, the server may use a static analysis tool to identify that a software module contains a function named “exportReport” and detects that “FileNotFoundError”is a potential error to users.
Based on the parsed operation function and abnormal condition information, the server generates a prompt sentence that is designed for use with a generative AI model. The prompt sentence is constructed in natural language, incorporating detailed and explicit instructions according to the detected functions and potential errors. For example, a prompt sentence may be:
“Explain step-by-step how to use the function ‘exportReport’, including how to handle ‘FileNotFoundError’ errors.”

Another example prompt would be:
“Write a user manual entry for the function ‘filterData’ in a web application. Explain step-by-step how to use it to filter displayed records. Additionally, list possible errors users might encounter, such as data not loading, and suggest troubleshooting steps.”
   The server then provides the generated prompt sentence as input to a generative artificial intelligence model, for example, an implementation based on a large language model framework deployed locally or accessed via a cloud-based AI service. The generative AI model produces document data in natural language text, such as stepwise instructions, error explanations, and troubleshooting guidelines.
   Subsequently, the server uses image generation and video generation software to create supplementary information. For image generation, tools such as a general purpose image editing program or automated screenshot capturing utility may be used. For video generation, screen recording software or automated animation tools are utilized to create instructional or demonstration videos. For example, the server may use a headless browser automation tool to generate annotated screenshots indicating the location of a function within a user interface, or trigger a screen recording of the operation sequence.
   The server then integrates the generated document data together with the image information and video information. This integrated content is packaged and delivered to a management system through network interfaces, enabling users to access up-to-date manuals and FAQs that contain both descriptive text and visual aids. The information management system may take the form of a documentation server or a web portal that is accessible via a terminal device such as a personal computer, smartphone, or tablet.
   The server continuously monitors program information, such as the source code repository, for changes. Upon detecting a modification, the server automatically repeats the aforementioned processes in order to update the documentation and supplementary content to reflect the new state of the software.
   The user accesses the published manual and FAQ content using a terminal device. When using the documentation portal, the user can read operation guides in natural language, view illustrative images and instructional videos, and, if necessary, submit evaluation information such as feedback or improvement requests via an information display device or a feedback form on the web portal. The server receives and analyzes the evaluation information from the user, and when appropriate, updates or improves the documentation and visual content accordingly.
   This embodiment allows for an automated, scalable, and interactive documentation workflow for software systems, leveraging generative AI models and dynamic prompt sentences to maintain and distribute rich, helpful content for end users.

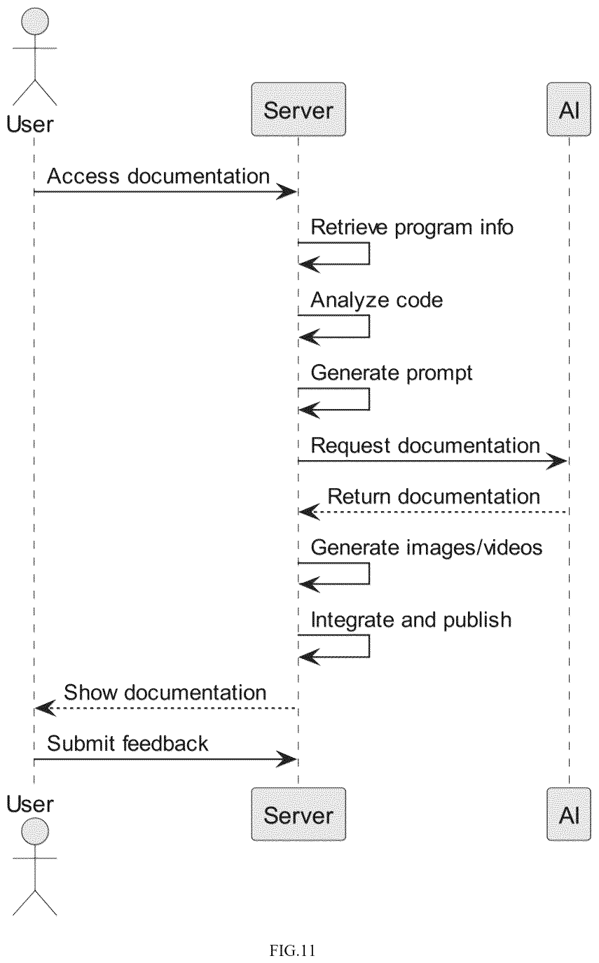

The following describes the processing flow using FIG. 11.

Step 1:

The server accesses the program information storage area and retrieves the latest software structure information, such as source code files and configuration scripts. As input, the server receives repository access credentials and a target location or identifier. The server processes the retrieval by making network requests or file system calls, and the output is the acquired program information files saved to a temporary processing directory.

### Step 2:

The server uses a static analysis tool to analyze the acquired program information and parses the files to extract operation function information (such as user-facing functions and methods) and abnormal condition information (such as error-handling code and exception types). The input for this step is the set of program information files from Step 1. The server runs the analysis software, processes the resulting metadata, and outputs structured data that lists available features and potential error cases in the form of JSON or another structured format.

### Step 3:

The server generates prompt sentences based on the results of the static analysis, incorporating the detected features and error conditions. The input for this step is the structured feature and error data from Step 2. The server programmatically creates natural language prompts using text templates, specifying details about detected features and error cases. The output is a set of prompt sentences prepared for the generative AI model.

### Step 4:

The server sends the prompt sentences to the generative AI model to automatically generate draft documentation, such as user manual entries and FAQ content. The input to this step is the set of prompt sentences from Step 3. The server transmits these prompts to an AI service or local AI instance, receives natural language instructional or explanatory text, and saves the output as draft document files.

### Step 5:

The server analyzes the generated documentation to identify areas that require visual explanations and then creates supplementary image and video information. The input is the draft documentation and identified documentation sections that benefit from visuals. The server uses tools such as automated screenshot utilities or screen recording software to generate annotated images and instructional videos. The output includes the created visual media files linked to corresponding sections in the documentation.

### Step 6:

The server integrates the generated text documentation, images, and videos, formats the combined content into the appropriate documentation structure, and distributes it to the management system for user access. The input is the full set of document text files and visual media from previous steps. The server performs content packaging, structure conversion (such as HTML or PDF generation), and uses network protocols or platform APIs to upload the materials. The output is an updated, accessible documentation portal or management system containing the latest user manuals and FAQs.

### Step 7:

The user accesses the distributed documentation using a terminal device through a web browser or an application interface. As input, the user has access to the portal address or app and retrieves documentation content by making selection or search requests. The server responds with the requested manual pages or FAQ entries, including embedded images and videos. The output for the user is an interface displaying understandable guidance and support content.

### Step 8:

The user provides evaluation information, such as feedback, comments, or improvement requests, through the documentation portal's feedback forms or interactive elements. The input is the user's submitted feedback data. The server collects this information, stores it in a feedback repository, and uses it as input for subsequent analysis. The output is a database or record of user evaluation information for further analysis and continuous improvement of documentation.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional systems, the creation and updating of user manuals and frequently asked questions (FAQs) for software products and physical devices are typically performed manually. As a result, it is difficult to provide users with up-to-date and accurate information in a timely manner, especially when rapid changes or updates are made to the underlying software or products. Additionally, existing documentation systems do not adapt to the individual emotional state or comprehension difficulties of each user during content consumption, which can reduce user satisfaction and hinder effective problem-solving. There is also a lack of continuous feedback mechanisms based on user experiences or emotions to optimize documentation quality over time.

The specific processing by the specific processing unit 290 of the data processing device 12 in Application Example 1 is realized by the following means.

The present invention provides a server comprising a processor configured to acquire program code, perform static analysis to extract function and abnormal behavior information, generate and input prompt sentences to a generative artificial intelligence model for automatic creation of structured natural language documents, generate visual content describing procedures, integrate and deliver such content via a management system and wide area network, estimate user emotions at the terminal, dynamically adjust the documentation according to user emotional states, and analyze accumulated emotional data and feedback for continuous document improvement. This enables rapid, automated generation and updating of user manuals and FAQs, delivery of personalized and adaptive support materials based on real-time user emotion and feedback, and ongoing optimization of documentation quality without excessive manual effort.

The term “program code” refers to a set of instructions written in a programming language that directs the operation and behavior of a computing system or application.

The term “static analysis” refers to the process of examining program code without executing it, in order to extract structural, functional, and behavioral information, as well as to identify potential errors, vulnerabilities, or abnormal conditions.
The term “function information” refers to data that describes the available operations, features, or tasks that a software application or system can perform.

The term “abnormal behavior information” refers to data relating to conditions, events, or patterns in a system's operation that deviate from expected behavior, such as error cases, exsceptions, or malfunction scenarios.

The term “structured information set” refers to an organized collection of extracted data, such as function information and abnormal behavior information, formatted for computational processing or input to other systems.
The term “prompt sentence” refers to a natural language input or query designed to instruct a generative artificial intelligence model to produce specific output, such as a user manual or FAQ entry.
The term “generative artificial intelligence model” refers to a computational model or system trained on large datasets to generate new content or data, including natural language documents, images, or videos, based on given input or queries.
The term “natural language document” refers to a document or content automatically created in a human-readable language, such as instructions, manuals, or frequently asked questions, intended to assist users.
The term “visual information” refers to image data and video data that visually depict operational steps, features, or troubleshooting procedures to supplement or clarify textual information.
The term “management system” refers to a computational platform or application for organizing, storing, integrating, and delivering documents and media content to information terminals.
The term “wide area network” refers to a communication infrastructure that connects computing devices and systems over a broad geographic area, such as the Internet.
The term “information terminal” refers to an electronic device, such as a personal computer or mobile terminal, capable of accessing, displaying, and interacting with delivered documentation or media content.
The term “emotion estimation engine” refers to a computational tool or software module that analyzes user data, such as facial expressions, voice, or interactions, to infer or estimate the emotional state of the user.
The term “emotional information” refers to data about the emotional state or reactions of a user, especially as determined by an emotion estimation engine during content interaction.
The term “feedback” refers to information provided by users regarding their experiences, satisfaction, issues, or suggestions in relation to the delivered documentation or system functionality.

One embodiment of the present invention will be described below in detail. The system of the present invention comprises at least a server, an information terminal, and a wide area network for communication between the server and the terminal. The server is equipped with a processor, storage, network interface, as well as application software capable of managing the programmed processes described below. The information terminal may be a general-purpose computing device, such as a personal computer, a smartphone, or a tablet, equipped with a web browser, camera, microphone, and emotion estimation software.

The server acquires program code from a code repository using download protocols such as Git over the Internet. The server is equipped with static code analysis software, for example, SonarQube or similar analysis tools. Upon retrieval of new or updated source code, the server performs static analysis to extract function information (such as available user-facing features) and abnormal behavior information (such as known error conditions or exception patterns).
The server composes a structured information set including the extracted function and abnormal behavior information, and generates a prompt sentence in natural language. The server submits this prompt to a generative AI model. Suitable generative AI models include, for example, large language models such as OpenAI GPT-4 or equivalent solutions. In response, the generative AI model outputs a natural language document, which may include a user manual, usage instructions, or frequently asked questions tailored to the specific program code features.
For example, the server may generate the following prompt:
Product name: Smart Cooker
Description: Multi-function cooking device
Features: Temperature adjustment, built-in timer
Error patterns: Sensor error, Overheat warning
Please generate a user-friendly user manual and a FAQ (3 typical questions and answers) in English.
   The server also generates visual information, such as explanatory diagrams or tutorial videos, based on the output content of the generative AI model. For this purpose, the server can utilize rich media processing software or APIs, such as the Adobe Creative Cloud API, video processing tools like FFmpeg, or custom video generation engines.
   The server integrates the generated natural language documents and visual information into a content management system. The management system may be implemented by web-based CMS software or a dedicated document delivery system. The server distributes the integrated documentation and visual content to information terminals via the wide area network.
   The information terminal receives the delivered content and displays it to the user. When the user accesses or interacts with the manual or FAQ through the terminal, the terminal activates an emotion estimation engine, such as an SDK for analyzing emotions or a cloud-based emotion estimation service. The engine obtains data from the terminal's camera and/or microphone to estimate the user's emotional state during content consumption.
   If the terminal or the server detects, for example, that the user is confused or frustrated, the server dynamically modifies the content delivered to the information terminal. This may include supplementing the manual with additional explanations, directly suggesting related FAQ entries, or providing video tutorials relevant to the user's current context.
   The server accumulates emotional and feedback data, and periodically analyzes such data using analytical software or machine learning modules. Based on the analysis, the server updates the structured information set and the prompt sentence input to the generative AI model for subsequent document revisions. In this way, documentation is iteratively optimized and personalized for future users.
   The user interacts with the displayed documentation and can submit explicit evaluation information or feedback regarding the usefulness or clarity of the documents and tutorial materials. Such feedback is transmitted to and stored by the server, contributing to continuous improvement of the system.
   Through the above configuration, the present invention enables fully automated, dynamic, adaptive, and emotion-responsive user support documentation generation and management suitable for software products or devices subject to frequent updates or complex operational procedures.

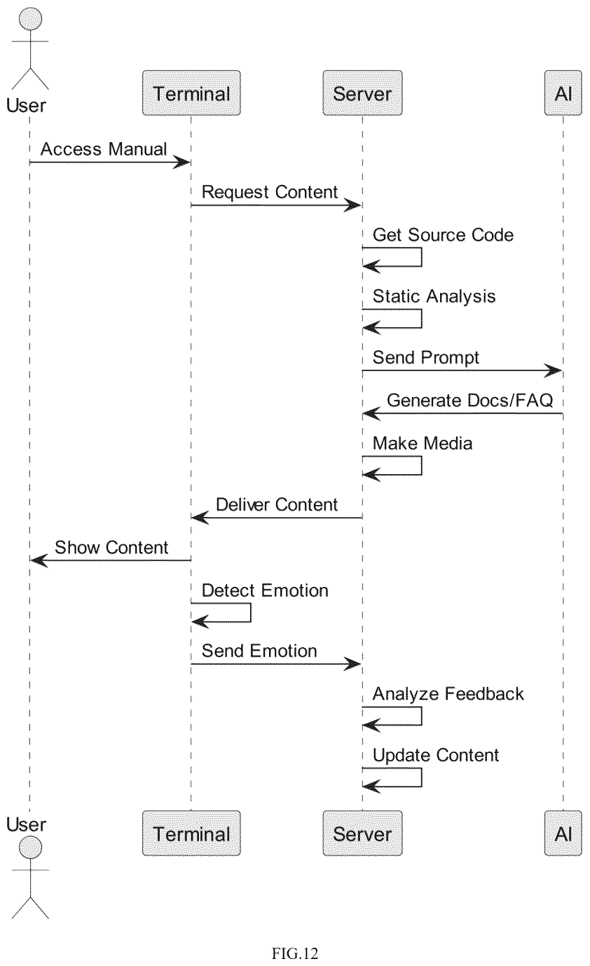

The following describes the processing flow using FIG. 12.

### Step 1:

The server connects to the source code repository over the wide area network and acquires the latest version of the program code. The input for this step is the repository URL and any necessary access credentials. The server downloads all relevant source code files, and the output is the set of acquired program code stored locally on the server.

### Step 2:

The server uses static analysis software to analyze the acquired program code. The input is the set of program code files obtained in Step 1. The server executes the static analysis tool, which parses and inspects the code to extract function information (such as user-facing features) and abnormal behavior information (such as error handling cases and potential failure points). The output is a structured information set, for example in JSON format, comprising the extracted function and abnormal behavior information.

### Step 3:

The server constructs a prompt sentence based on the structured information set created in Step 2. The input for this step is the structured information set, describing product name, description, available features, and error patterns. The server processes this data to compose a natural language prompt sentence suitable for a generative AI model. The output is the formatted prompt sentence.

### Step 4:

The server sends the prompt sentence to a generative AI model via API and receives a natural language user manual and FAQ as output. The input is the prompt sentence from Step 3. The server interacts with the generative AI model, which synthesizes comprehensive human-readable documentation. The output is a set of natural language text documents covering operational guides and frequently asked questions based on the analyzed code.

### Step 5:

The server generates visual content to supplement the manual and FAQ documents. The input is the natural language output from the generative AI model, along with relevant procedure or usage details. The server uses image and video generation software to create diagrams, flowcharts, or instructional videos. The output is a set of visual information files linked to corresponding manual sections.

### Step 6:

The server integrates the natural language documents and visual information into a content management system. The input is the set of generated documents and media from Steps 4 and 5. The server organizes, indexes, and uploads all materials to the management platform, converting content as necessary for distribution. The output is an up-to-date set of user-support content accessible through the management system.

### Step 7:

The server delivers the integrated content to information terminals via the wide area network. The input is the managed set of manuals, FAQs, and rich media. The server transmits this content in appropriate formats (e.g., HTML, PDF, MP4) to information terminals, which receive and display the information to the user. The output is that the user's terminal holds the latest documentation and training materials.

### Step 8:

The terminal activates an emotion estimation engine when the user interacts with the delivered content. The input is user interaction data such as facial expressions, voice, and behavior, captured by the terminal's camera and microphone. The emotion estimation engine processes this input to determine the user's emotional state. The output is an emotion information set, such as indicators of confusion, stress, or satisfaction.

### Step 9:

The terminal sends the emotion information to the server. The input is the emotion information set generated in Step 8. The server receives and logs this data for the corresponding user session. The output is a database or log entry recording real-time emotional feedback.

### Step 10:

The server analyzes incoming emotion and feedback data. The input is accumulated emotion information and explicit user feedback. The server applies data analysis and pattern recognition methods to detect areas where users experience difficulty or negative emotions. If a user demonstrates confusion or stress regarding certain topics, the server dynamically adjusts the content delivered to that user by providing additional explanations, related FAQs, or video tutorials. The output is a dynamically adapted set of support documents on the user's information terminal.

### Step 11:

The server aggregates emotion and feedback results over time. The input is the collection of emotional and evaluative data across multiple user sessions. The server applies statistical analysis and, optionally, machine learning to identify patterns or recurrent issues in the documentation. The server updates the structured information set and the prompt sentences used for subsequent generative AI runs, so that the next generation of manuals and FAQs reflects user needs and emotional responses. The output is improved documentation and multimedia content tailored through continued iteration.

It is also possible to incorporate an emotion engine for estimating the user's emotions. That is, the specific processing unit 290 may estimate the user's emotions using an emotion identification model 59, and perform specific processing based on the estimated emotions.

### EXAMPLE 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems for generating user manuals and frequently asked questions (FAQ) are insufficient in their ability to automatically adapt and improve content based on updates to program information or user feedback. Additionally, such systems generally lack the capability to dynamically present content that is customized according to the emotional state of the user, resulting in suboptimal user experience and diminished usability when users are faced with operational challenges or confusion.

The specific processing by the specific processing unit 290 of the data processing device 12 in Example 2 is realized by the following means.

The present invention provides a server comprising a processor configured to acquire program information, perform static analysis to extract operation function information and abnormal state information, generate guidance content data using a natural language processing mechanism, automatically produce visual and audio output based on operation procedures, integrate and distribute such information, determine user emotional state from motion or audio data, and dynamically optimize and present content based on said emotional state. This enables automatic, adaptive, and user emotion-responsive generation and delivery of user manuals and FAQ, thereby improving usability and overall user experience.

The term “program information” refers to data representing the implementation details of software, including but not limited to source code, configuration files, and related structural or descriptive files.

The term “static analysis” refers to the process of examining program information without executing it, in order to extract operation function information and abnormal state information such as potential errors or logical structures.
The term “operation function information” refers to data indicating the features, actions, or behaviors available within a software program that pertain to user operations.
The term “abnormal state information” refers to data representing conditions, errors, or states within the software program that may lead to unexpected or undesired outcomes during its execution.
The term “natural language processing mechanism” refers to a computing resource, including hardware and software, that is capable of interpreting, generating, or analyzing human languages to automatically create guidance content data.
The term “guidance content data” refers to instructions, manuals, frequently asked questions, or similar information generated for the purpose of assisting users in understanding and operating a software program.
The term “visual output information” refers to graphics, images, videos, or other visual media that illustrate software operation procedures for user assistance.
The term “audio output information” refers to sound, voice guidance, or audio effects generated to facilitate user understanding of software operation procedures.
The term “information management apparatus” refers to a hardware and/or software structure that integrates, stores, and distributes generated content and related data within the system.
The term “user motion information” refers to data acquired from the user's physical actions, such as facial expressions or body movements, through input devices including but not limited to cameras or sensors.
The term “audio information” refers to data acquired from the user's speech, tone, or other audio signals through microphones or equivalent audio-capturing apparatus.
The term “state determination mechanism” refers to a computational resource or process for analyzing user motion or audio information to infer the user's emotional state or cognitive engagement.
The term “emotional state information” refers to data representing the inferred emotion or psychological condition of the user, such as confusion, satisfaction, frustration, or interest.
The term “dynamic optimization” refers to the real-time or near real-time adjustment and customization of guidance content data and output information based on changing user conditions, including emotional state information.

One embodiment of the invention is a system comprising a server and at least one terminal device, both connected through a network. The server comprises a processor that executes the program for realizing the invention.

The server is equipped with storage, a processor, and is operated by executing application software and various analysis tools. The storage holds program information such as source code, configuration files, and related data. The processor is capable of accessing program repositories (for example, version control systems), acquiring the latest program information, and storing it for further processing.
The server uses a static analysis tool, such as a general-purpose code analyzer, to analyze acquired program information. This analysis extracts operation function information, such as available features, and abnormal state information, such as possible error conditions or states. The extracted information is stored in a structured format for later use.
To generate manual and FAQ content, the server incorporates a natural language processing mechanism such as a generative AI model. In an exemplary implementation, the server utilizes a generative AI model to which it sends a prompt sentence and the extracted information. The generative AI model responds by generating human-readable guidance content data, including instructions, user manuals, and FAQ entries.
Additionally, the server creates visual output information, such as instructional images or videos, and audio output information (for example, voice guidance). For this purpose, the server may employ media processing software, such as a general editing application, to automatically generate such content based on operation procedure information provided as input.
The generated guidance content data and output media are integrated and organized within an information management apparatus. The server then distributes or transmits the compiled content to one or more terminal devices for user access.
Each terminal is equipped with a user interface, camera, microphone, and communication module. When a user accesses the content, the terminal collects motion information (for example, facial expressions) and audio information (for example, speech and tone) using the built-in camera and microphone. The terminal then transmits this sensor data to the server or to a dedicated state determination mechanism.
The state determination mechanism, which may include hardware and software for emotion detection, processes the received information and generates emotional state information, such as indicators of confusion or satisfaction. Depending on the user's emotional state, the server dynamically optimizes the content, selecting more detailed manuals, step-by-step guidance, or alternative visual and audio information, and delivers the optimized information back to the terminal for presentation to the user. The system is capable of performing this process iteratively and in near real-time.
The system can further detect updates in the program information automatically, and, based on such updates, can revise or regenerate the guidance content data and output media as necessary. Furthermore, users are provided with an interface for submitting feedback or queries, which the system analyzes to continuously improve and refine the manually generated or AI-generated guidance content.
As a concrete example, suppose a user is interacting with a cooking application. When the user accesses the “cake recipe” manual and is detected as confused (such as by a perplexed facial expression or uncertain voice tone), the terminal transmits this state to the server. The server then presents additional step-by-step video guidance or a specific FAQ related to common cake recipe mistakes.
An example of a prompt sentence used for generating content with the generative AI model is: “Please generate instructions and FAQ entries for the detected program features and errors, particularly focusing on cooking application scenarios where the user may encounter difficulty, such as cake baking steps.”

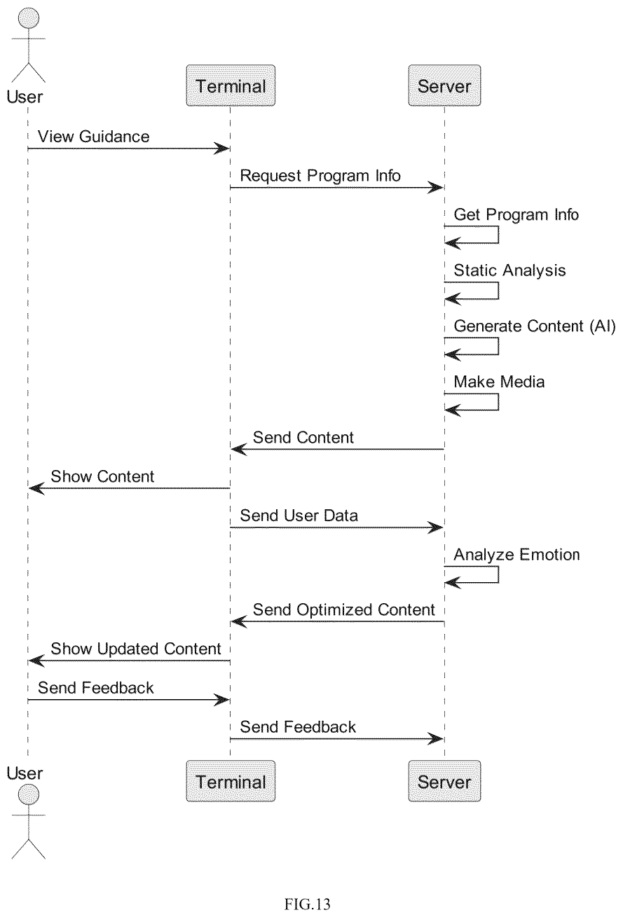

The following describes the processing flow using FIG. 13.

### Step 1:

The server acquires program information from a program repository. As input, the server uses a repository address and authentication credentials. The server processes this input by establishing a network connection and retrieving the latest version of the program files. As output, the server stores the collected program files and configuration data in a designated local directory.

### Step 2:

The server performs static analysis on the acquired program information. As input, the server takes the locally stored program files. The server runs a static analysis tool to extract operation function information (such as available features) and abnormal state information (such as potential errors). As output, the server generates structured data files that list detected functions and possible error conditions.

### Step 3:

The server generates guidance content data using a generative AI model. The input includes the extracted operation function information and abnormal state information from Step 2, together with a prompt sentence. The server sends this information to the generative AI model, which processes the input and outputs user manual text and FAQ content. The server saves the generated guidance content as human-readable documentation files.

### Step 4:

The server automatically generates visual output information and audio output information based on operation procedure information. The server takes as input the results of static analysis and the procedural data for each function. It uses media editing software to create tutorial images, videos, and audio explanations. The generated output consists of media files that visually and aurally demonstrate software operation procedures.

### Step 5:

The terminal presents the guidance content data and output information to the user. As input, the terminal receives documentation and media files from the server. The terminal displays the manual, FAQ, images, and videos on its user interface, and plays audio explanations so the user can easily follow along.

### Step 6:

The terminal collects user motion information and audio information while the guidance content is being accessed. As input, the terminal uses a built-in camera and microphone to capture the user's facial expressions and voice. The terminal processes this input by packaging the sensor data and transmitting it to the server or a state determination mechanism.

### Step 7:

The server determines the user's emotional state by processing the motion and audio information. The input consists of sensory data collected by the terminal. Using an emotion analysis mechanism, the server evaluates the user's state (such as confusion or frustration). As output, the server generates emotional state data associated with the user session.

### Step 8:

The server dynamically optimizes and updates the guidance content data and output information according to the detected emotional state. As input, the server uses the emotional state data and the current user context (such as which manual section or video is being viewed). The server selects more detailed instructions, additional FAQs, or alternative videos and sends them to the terminal. The output is real-time, personalized content that assists the user more effectively.

### Step 9:

The user provides feedback or submits a query through the terminal interface. The input is feedback or questions entered by the user via text form or voice input. The terminal sends this data to the server, where it is analyzed for further improvement of the guidance content data and output information. The output is a logged record of user feedback that the server can use to refine future guidance generation.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional user manuals and FAQ systems are typically static and cannot flexibly respond to the user's emotional state or level of understanding. This often leads to user confusion, frustration, and a decrease in satisfaction, especially when operating unfamiliar equipment or software. In particular, existing systems fail to automate the extraction of operational procedures and error conditions from the actual source code, and lack mechanisms to dynamically adapt instructional content to individual users based on real-time emotional feedback.

The specific processing by the specific processing unit 290 of the data processing device 12 in Application Example 2 is realized by the following means.

The present invention provides a server comprising a processor configured to acquire operation description information, analyze the information to extract user operation functions and abnormal operation conditions, generate informative guidance text and question-and-answer collections using a natural language information generation module, automatically create visualization and moving image information for procedural guidance, integrate and distribute the generated information through an information delivery management device, and dynamically adjust the instructional content based on user emotional feedback acquired from user devices. This enables the automatic generation and dynamic personalization of user manuals and FAQ content according to the user's real-time needs and emotional state, thereby improving user experience and satisfaction.

The term “operation description information” refers to information that describes the functions, processes, and behaviors of a product or software, typically including source code, scripts, or other technical documents.

The term “user operation functions” refers to functions or procedures that can be performed by a user when interacting with a product or software, such as starting, configuring, or stopping an operation.
The term “abnormal operation conditions” refers to situations or states in which a product or software does not operate as intended, often resulting in errors or malfunctions that require user attention.
The term “informative guidance text” refers to textual content that provides instructions, directions, or explanations to assist the user in operating a product or software.
The term “question-and-answer collection” refers to a set of frequently asked questions (FAQs) and their corresponding answers designed to address common user inquiries and problems.
The term “natural language information generation module” refers to a computational component or engine configured to automatically generate human-readable text in natural language based on input data, such as operation functions and error conditions.
The term “visualization information” refers to images, diagrams, or other graphic content that visually represent procedural steps, component locations, or operational elements.
The term “moving image information” refers to video or animation content that demonstrates procedures, operational steps, or troubleshooting processes in motion.
The term “information delivery management device” refers to a computing system or platform that manages, organizes, and distributes generated instructional content to user devices.
The term “user emotion information” refers to data representing the emotional state or response of a user, which can be obtained from user inputs, expressions, voice, or behavioral signals.
The term “response information” refers to feedback, comments, or evaluations submitted by users regarding instructional content or user experience.

One embodiment of the present invention will be described below.

The system comprises a server and a terminal (such as a user device), which interact over a network. The server includes a processor and storage components, while the terminal is equipped with imaging and audio input/output devices such as a camera and microphone, as commonly found on smartphones and tablets.
The server is configured to acquire operation description information, which may be in the form of source code, configuration files, or technical documentation from a data repository. To accomplish this, the server utilizes network access and standard protocols such as HTTP or secure copy. Examples of hardware for the server include commercially available server computers; for software, commonly used repository systems and code management tools are employed.
Once the operation description information is acquired, the server utilizes a static code analysis tool or parser, which can be implemented using general-purpose programming languages. Specific examples include open-source analysis frameworks or proprietary scripts. The server analyzes the operation description information to extract user operation functions and abnormal operation conditions. The results of this analysis are stored in structured datasets for further processing.
The processor on the server then employs a natural language information generation module, such as a generative AI model, to generate informative guidance text and a question-and-answer collection. This may be achieved by submitting prompt sentences constructed from extracted function names and error condition keywords to a generative AI model API. For example, the generative AI model could be a cloud-based large language model service.
Example prompt sentences include:
“Write a simple, detailed manual for using the new product with the following functions: start, clean, and handle error ‘component empty.’”
“The user is confused by the cleaning procedure. Generate an easy-to-understand, step-by-step explanation and troubleshooting tips.”
“If the user is frustrated, provide additional answers and reassurance.”
   For the generation of visualization information and moving image information, the server may utilize image generation tools (such as drawing APIs) and video processing software. An example includes scriptable video editing suites, which can generate procedure illustrations, step diagrams, and video demonstrations based on the operation functions previously extracted.
   The generated guidance text, question-and-answer collection, visualization, and moving image information are integrated by the server and managed using an information delivery management device, such as a content distribution server or cloud management platform. The server controls the delivery of this instructional content to one or more user terminals.
   The terminal, such as a smartphone or tablet, is configured to acquire user emotion information via its camera and microphone, with the user's permission. The terminal executes an emotion recognition component, which may be implemented as a dedicated module or use a cloud-based emotion analysis service. Through this process, real-time emotion data, such as confusion or frustration detected in the user's expressions or voice, is captured and relayed to the server.
   On receiving user emotion information, the server analyzes the data and, if necessary, dynamically adjusts the relevant portions of the guidance text, question-and-answer collection, visualization information, or moving image information. The modifications may be performed using further prompt sentences directed to the generative AI model. For example, if the server receives “confused” as an emotional status, it sends an updated prompt:
“The user appears confused about using the product. Generate a highly detailed guide with visual tips.”
   The updated content is then redistributed to the terminal for display to the user.
   In a specific example, when a user attempts to operate a device, the terminal displays the generated manuals and videos. If the user shows signs of confusion, the system detects this and immediately provides a tailored, more detailed video tutorial, helping the user resolve their issue effectively.
   This embodiment illustrates the practical means by which the invention enables the automatic generation and real-time personalization of instructional content according to user needs and emotional state, by leveraging general-purpose server hardware, standard user devices, and generative artificial intelligence models.

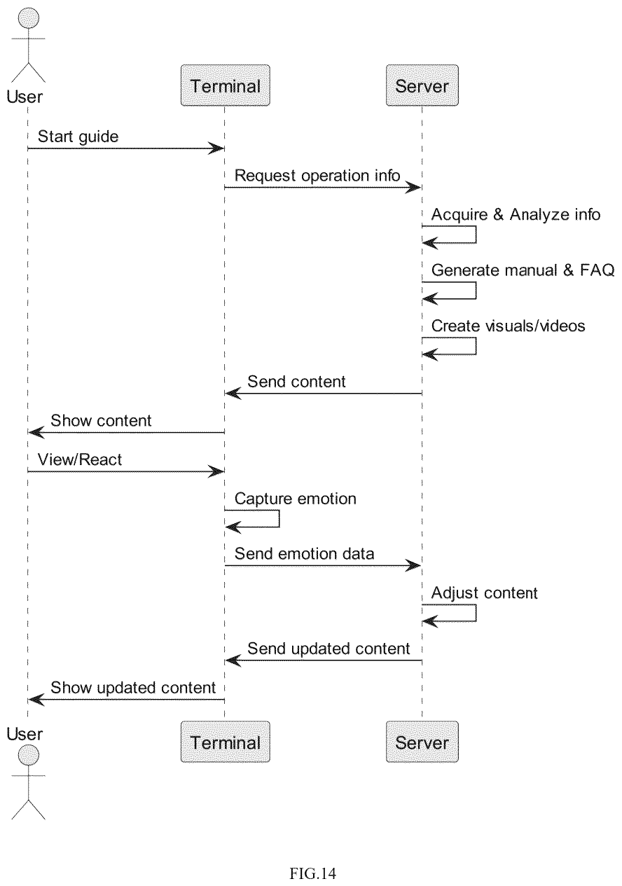

The following describes the processing flow using FIG. 14.

### Step 1:

The server acquires operation description information from a repository or documentation database. The input is the address or access information for the source of operation description information, such as a repository URL and authentication credentials. The server establishes a network connection, authenticates, and downloads the relevant files. The output is a set of operation description data files stored locally on the server.

### Step 2:

The server analyzes the acquired operation description information to extract user operation functions and abnormal operation conditions. The input is the set of downloaded data files. The server parses the files using a static analyzer or a parser module to identify functions available to users and error-handling logic. The data processing involves syntax analysis, pattern matching, and extraction of function and error keywords. The output is structured information, such as a list of user operations and a list of error conditions.

### Step 3:

The server generates informative guidance text and a question-and-answer collection using a natural language information generation module. The input is the structured list of user operations and error conditions from Step 2. The server constructs prompt sentences and sends them to a generative AI model. The generative AI model processes these prompts and returns explanatory text and FAQs. The output is formatted instructional content and an FAQ document.

### Step 4:

The server creates visualization information and moving image information to supplement the guidance text. The input is the operation steps and key functions identified in the previous steps. The server uses image generation modules (such as drawing APIs) to produce procedural diagrams and invokes video generation scripts to edit or assemble instructional videos. Data processing includes mapping operational steps to visual elements and sequencing video clips. The output is a set of images (e.g., diagrams) and video files demonstrating key procedures.

### Step 5:

The terminal acquires user emotion information when the user interacts with the instructional content. The input is real-time audio and video captured through the device's camera and microphone. The terminal passes this data to an emotion recognition module, possibly using a cloud-based analysis service. The processing involves facial expression detection, voice tone analysis, and classification of user emotion. The output is emotion status data, indicating states such as “neutral,” “confused,” or “frustrated.”

### Step 6:

The server receives user emotion data and dynamically adjusts the instructional content accordingly. The input is the emotion status data and the previously generated instructional content. If the emotion indicates confusion or frustration, the server constructs new, tailored prompt sentences and submits them to the generative AI model to generate more detailed explanations, tips, or alternative formats. The data processing includes content selection, AI model interaction, and content revision. The output is modified text, updated diagrams, or additional tutorial videos.

### Step 7:

The terminal receives the dynamically updated content from the server and presents it to the user. The input is the revised instructional content, which may include new text, diagrams, or videos. The terminal updates its display, launches the appropriate viewer/player application, and makes the content immediately accessible to the user. The output is an improved, context-sensitive instructional experience for the user.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

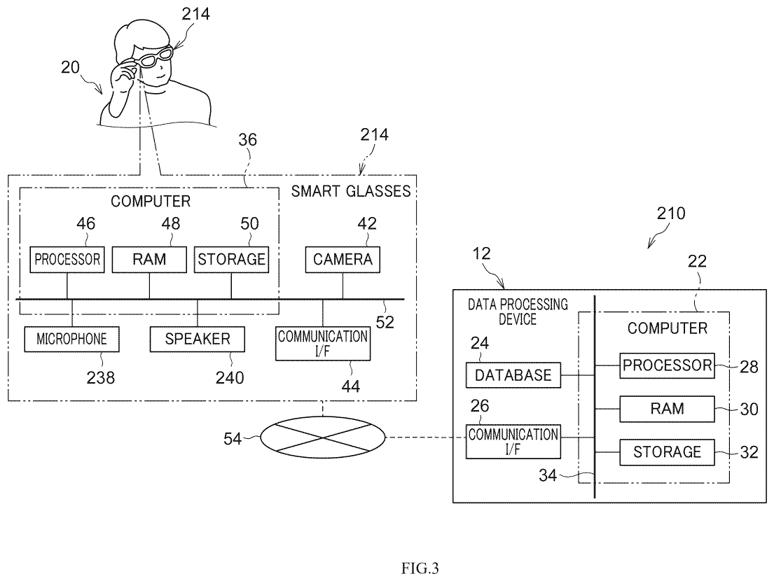

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

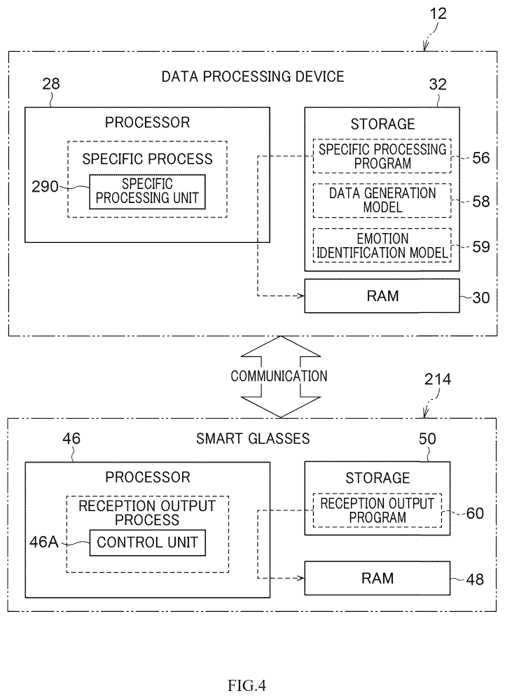

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

### Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

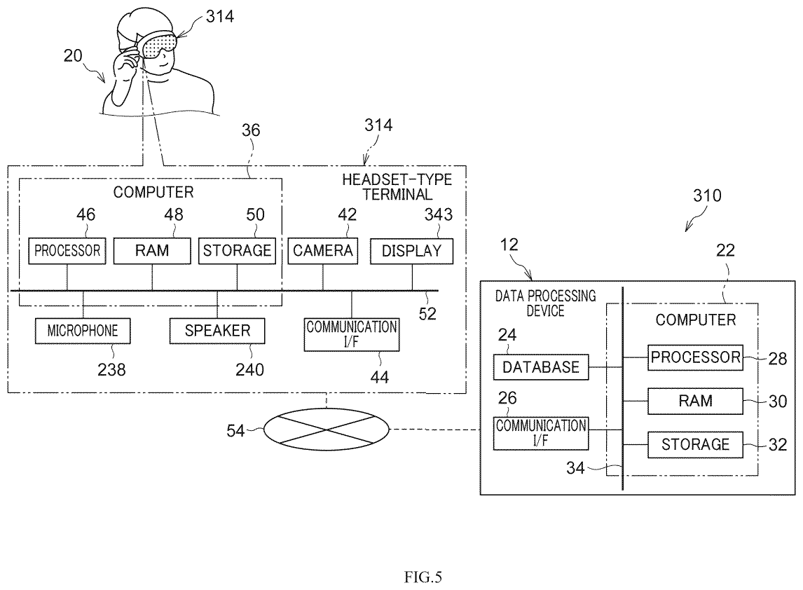

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

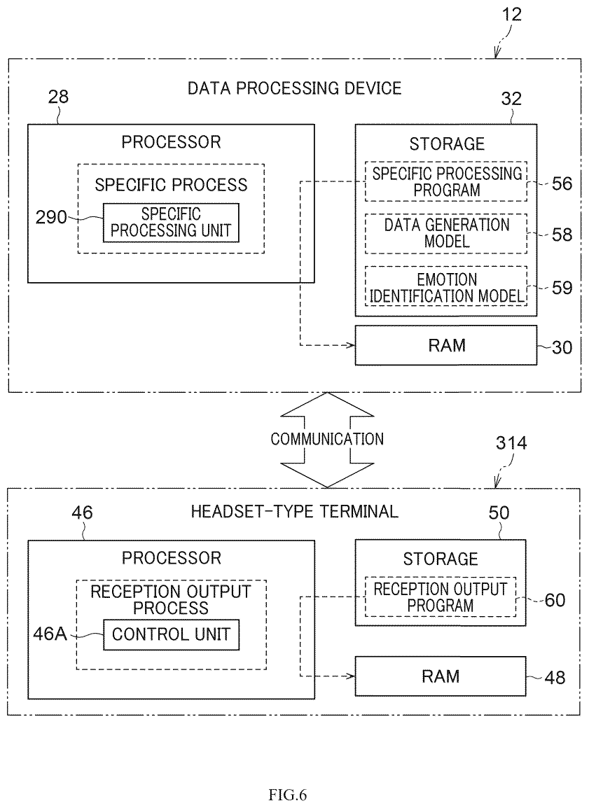

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

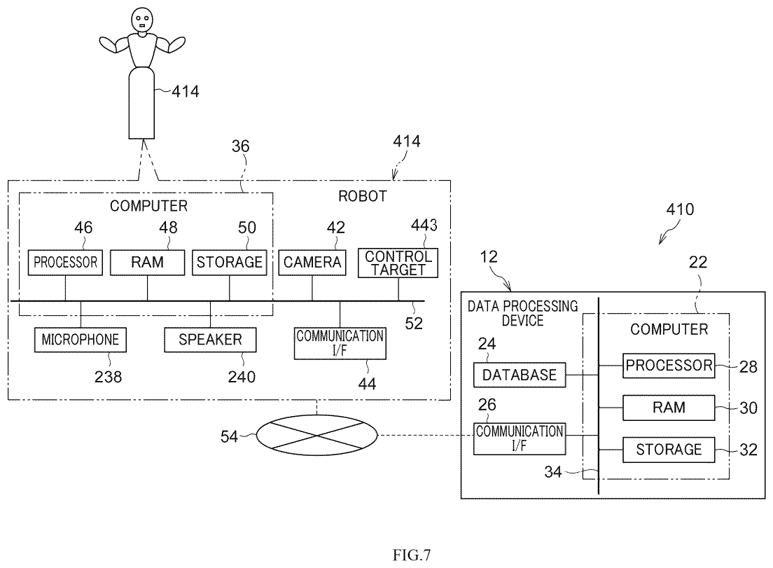

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

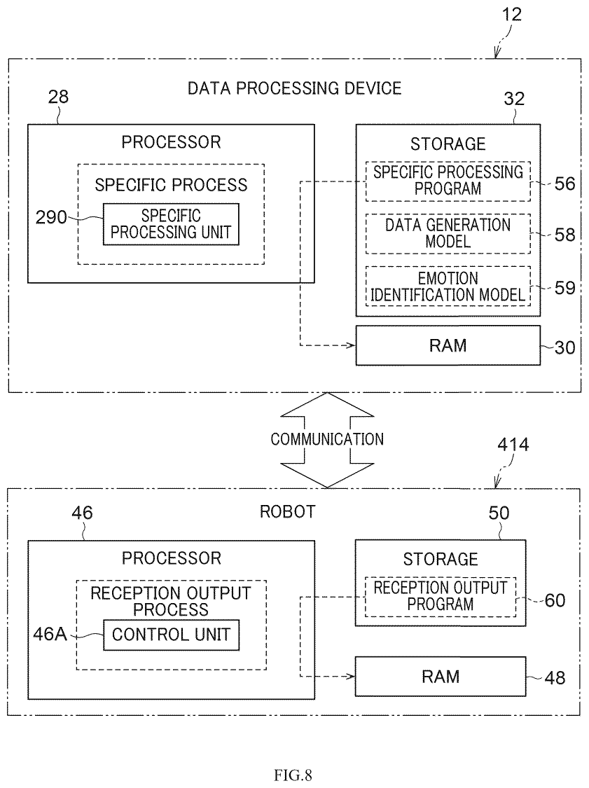

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

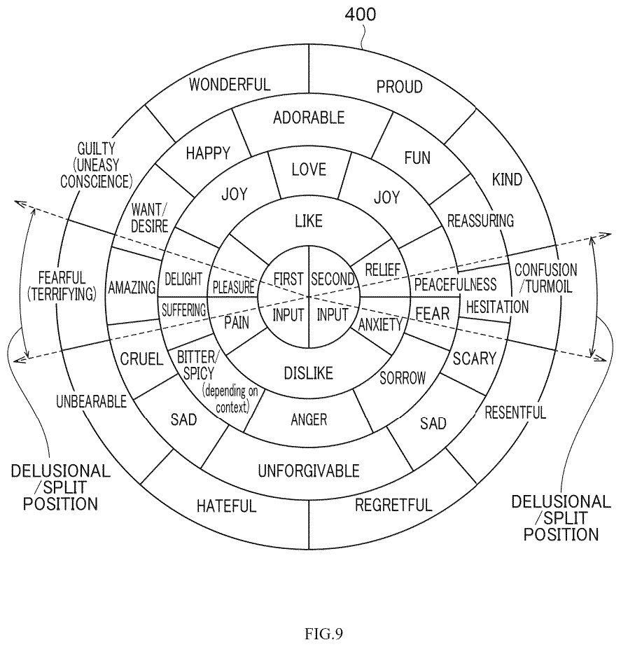

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety.

Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more”and “want to know more”is experienced.

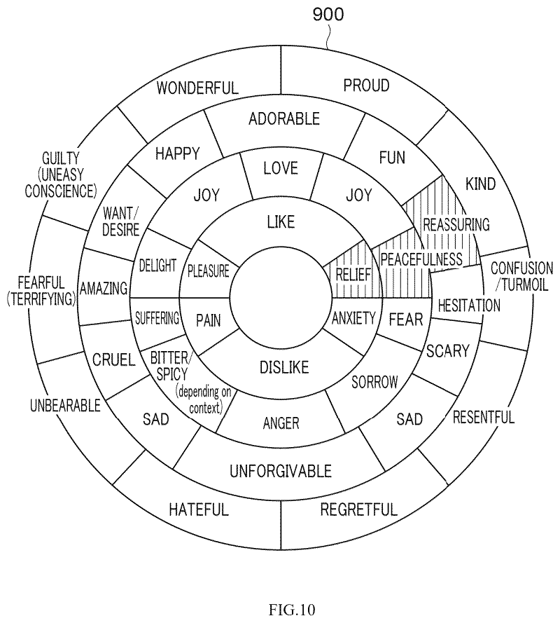

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor, wherein the processor is configured to
acquire program information including software structure information from a management information storage area,
analyze the acquired program information with an analysis processing device to extract operation function information and abnormal condition information,
generate a prompt sentence for a natural language processing device based on the extracted operation function information and abnormal condition information, input the prompt sentence into a generative artificial intelligence model, and automatically generate document data,
automatically generate image information and video information as supplementary information based on the generated document data by using an image generation device and a video generation device, and
integrate the document data, the image information, and the video information, and distribute them to a management system via an information providing device.

### Supplementary 2

The system according to supplementary 1, wherein the processor is configured to
monitor a change state of the program information and automatically update the document data, the image information, and the video information based on a detected changed part.

### Supplementary 3

The system according to supplementary 1, wherein the processor is configured to
analyze evaluation information obtained from a user through an information display device and improve the content of the document data, the image information, and the video information.

### Application Example 1

### Supplementary 1

A system comprising a processor, wherein the processor is configured to
acquire program code;
perform static analysis on the acquired program code to extract function information and abnormal behavior information;
generate a structured information set including the extracted function information and abnormal behavior information, and input a prompt sentence based on the structured information set to a generative artificial intelligence model to automatically generate a natural language document;
automatically generate visual information including image information and video information that visually describes operation procedures based on the content of the natural language document;
integrate the generated natural language document and visual information into a management system and deliver the integrated information to an information terminal via a wide area network;
estimate a user's emotional state at the information terminal using an emotion estimation engine, and dynamically adjust the delivered information content in accordance with the estimated emotional state; and
analyze accumulated emotional information and feedback from users and reflect analysis results in subsequent document generation.

### Supplementary 2

The system according to supplementary 1, wherein the processor is configured to
detect changes in the program code, extract update information corresponding to the changed portions, and automatically update the natural language document and the visual information.

### Supplementary 3

The system according to supplementary 1, wherein the processor is configured to
receive evaluation information and emotional information from a user, analyze such information, and improve subsequently generated natural language documents and visual information based on the analysis.

### Example 2

### Supplementary 1

A system comprising a processor, wherein the processor is configured to
acquire program information,
perform static analysis on the acquired program information to extract operation function information and abnormal state information,
input the extracted information and command sentences to a natural language processing mechanism to automatically generate guidance content data,
automatically generate visual output information and audio output information based on operation procedure information,
integrate the generated guidance content data and output information into an information management apparatus and distribute them in a distributable format,
acquire user motion information or audio information and determine emotional state information using a state determination mechanism, and
dynamically optimize and present the guidance content data and output information according to the emotional state information.

### Supplementary 2

The system according to supplementary 1, wherein the processor is configured to detect an update of the program information and automatically update the guidance content data and output information based on the update information.

### Supplementary 3

The system according to supplementary 1, wherein the processor is configured to acquire user response information or inquiry information and analyze said information to improve the guidance content data and output information.

### Application Example 2

### Supplementary 1

A system comprising a processor, wherein the processor is configured to
acquire operation description information;
analyze the acquired operation description information to extract user operation functions and abnormal operation conditions;
automatically generate informative guidance text and a question-and-answer collection based on the extracted information using a natural language information generation module;
automatically generate visualization information and moving image information for procedural explanation based on the guidance text and question-and-answer collection; integrate and distribute the generated information to an information delivery management device; and
analyze user emotion information acquired from a user device, and dynamically adjust at least a part of the generated guidance text, question-and-answer collection, visualization information, or moving image information according to the user emotion information, and redistribute the adjusted information.

### Supplementary 2

The system according to supplementary 1, wherein the processor is configured to
detect a change in the operation description information and automatically update the guidance text, question-and-answer collection, visualization information, or moving image information based on the changed portion.

### Supplementary 3

The system according to supplementary 1, wherein the processor is configured to
receive response information from the user and analyze the response information to improve the guidance text, question-and-answer collection, visualization information, or moving image information.

What is claimed is:

1. A system comprising a processor,
wherein the processor is configured to
acquire source code,
analyze the acquired source code and extract operational functions and error conditions,
automatically generate a user manual and FAQ in natural language based on the generated data,
automatically generate images and videos of operation procedures as rich content, and
integrate and distribute the generated content via a management system.

2. The system according to claim 1, wherein the processor is further configured to detect changes in the source code and automatically update the user manual and FAQ based on the changes.

3. The system according to claim 1, wherein the processor is further configured to receive feedback from users, analyze the feedback, and improve the user manual and FAQ based on the feedback.
